(19) United States
(12) Patent Application Publication
(10) Pub. No.: US 2002/0073212 A1
(43) Pub. Date: Jun. 13, 2002

(54) Wireless web browsing terminal and hub

(76) Inventors: Daniel D. Sokol, San Jose, CA (US); Ralph I. Miller, Kentfield, CA (US); Dimitry Dukhovny, San Bruno, CA (US); Kirk H. Knight, Alameda, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/735,688

(22) Filed: Dec. 12, 2000

Related U.S. Application Data
(60) Provisional application No. 60/248,114, filed on Nov. 13, 2000.

(51) Int. Cl. G06F 15/167

(52) U.S. Cl. 709/229; 709/227

(57) ABSTRACT

A system in accordance with the invention provides a wireless LAN having terminals that require virtually no setup or installation by the user. Each terminal is in wireless communication with a hub that has access to an off-site network, such as the Internet. Each terminal allows web browsing, e-mail, and chat access, but shelters the user from exposure to the operating system, creating a streamlined, easy-to-use, and inexpensive system.

### FIELD OF INVENTION

The present invention generally relates to wireless local area networks (LANs), and particularly to wireless LANs with web browsing terminals.

### BACKGROUND

In the past decade the Internet has gained considerable use and popularity in the United States. This is not the case in many other countries. For instance, in China and other countries, few businesses or individuals own a personal computer. Not only are personal computers (PCs) expensive to purchase, but they are frequently difficult to operate. Thus, the total cost of ownership of PCs is too high. In addition, few Chinese businesses are filly wired for electrical or phone access. Often, a business is lucky to have a single power outlet in a room. Thus, PCs are often impractical to use.

To make operation and setup of a “computer” easier for the end-user, some companies have proposed a “thin client” system. Examples of these thin clients are made by Sun (Sun Ray) and IBM (Netvista). In such a system, each “client” is essentially a dumb terminal and all applications are run from a central server. Hence, the individual user has little setup or maintenance to contend with while being provided with the ability to use applications that would otherwise require a PC. Thus, these “thin clients” or dumb terminals are sometimes referred to as Information Appliances. Despite the ease of use for the terminal user (the individual at each thin client station), these systems need a fast and sophisticated central server. As result, more administrative time, and not less, is spent tending to these systems, actually causing their cost to go up relative to their standard PC counterparts. Therefore, these types of systems are unsatisfactory to the Chinese needs.

Other companies have proposed Internet appliances, basically nothing more than a web browsing machine. These appliances are built with the assumption that each will connect to the Internet. Therefore, each appliance has a modem. In addition, these appliances typically include a 10BaseT connector for LAN connectivity, e.g., connectivity with each other. But in a situation where an office has very few electrical outlets and is not wired throughout for phones, let alone ethernet, these devices are impractical. Moreover, like PCs these appliances often use operating systems such as Microsoft products. As a result, these appliances require set up and installation actions on the part of the user—not always simple actions. Further, these products are also consumer products, designed to handle media-rich data and applications, but not generally designed for businesses or with business applications in mind. The Chinese typically are also not willing to purchase products that they do not believe operate well, including Microsoft products. Thus, currently available web appliances are not ideal to provide Internet connectivity to Chinese businesses.

Finally, the Chinese frequently do not see the advantages of Internet communications. Therefore, it is desirable to develop a system acceptable to the Chinese business market, which will encourage Internet connectivity among the Chinese business population.

### SUMMARY

A system has been designed that will encourage Internet connectivity in the Chinese business market. The system includes a wireless local area network (WLAN). The WLAN includes a plurality of terminals in wireless communication with a hub. The hub is in communication with an off-site network, such as the Internet.

Each terminal is streamlined to allow easy setup and use. In one embodiment, the terminals store only a scaled-down operating system, but are capable of retrieving from the hub a web browser, an e-mail application, and a chat application—applications useful for the informational exchange frequently required in business.

In many embodiments, the terminals are equipped with a smartcard reader, where each smartcard is associated with a particular user. Use of smartcards allows users to recall account and session information, and allows such recall to occur at any terminal in the WLAN.

A system in accordance with the invention is easy to set up, use, and maintain, is inexpensive, and is directed to informational business needs.

### BRIEF DESCRIPTION OF THE DRAWINGS

The present invention is described with respect to particular exemplary embodiments thereof and reference is accordingly made to the drawings in which:

FIG. 1 is a generalized functional block diagram of a system in accordance with an embodiment of the invention;

FIG. 2 is a generalized functional block diagram of a hub in accordance with an embodiment of the invention;

FIG. 3 is a generalized flow diagram of the log on procedure of a system in accordance with an embodiment of the invention;

FIG. 4 is a generalized flow diagram of the log off procedure of a system in accordance with an embodiment of the invention; and

FIG. 5 is a generalized block diagram illustrating an update card in a smartcard reader in accordance with an embodiment of the invention.

### DETAILED DESCRIPTION

Overview

A system in the accordance with an embodiment of the invention provides a wireless local area network (WLAN) having terminals that require virtually no set up or installation by the user. Each terminal communicates in a wireless manner with a hub that has Internet access. As a result, each terminal allows business communications such as web, e-mail, and chat access but little more. Thus, the terminals in accordance with the invention are easy to use, set up, and maintain. Moreover, they are inexpensive both to purchase and to operate.

Structure

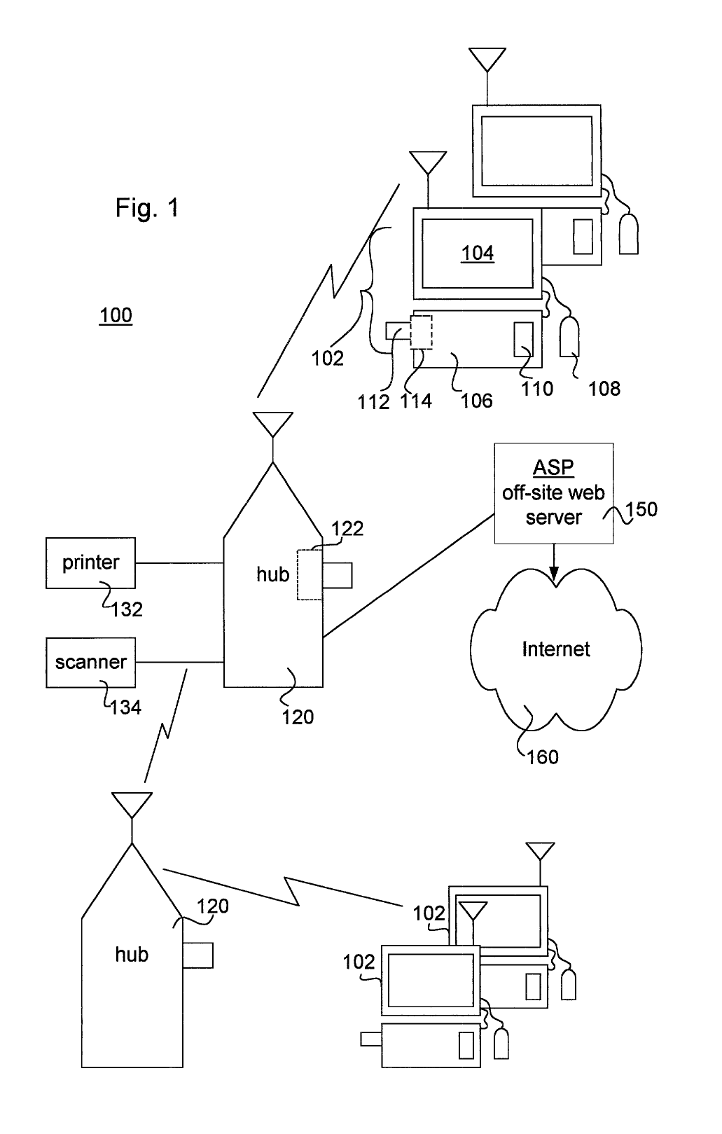

FIG. 1 shows a system 100 in accordance with the invention. As shown, the system includes one or more terminals 102. Each of the terminals communicates with a hub 120 using a wireless connection such as the IEEE 802.11 Wireless LAN Standard, which is known by those with skill in the art.

Each terminal includes a processor and memory (not shown), a display 104, and one or more input devices. The input devices shown include a keyboard 106, a mouse (or other pointing device) 108, and a tablet 110. In some embodiments the tablet 110 is built into the keyboard 106 as shown in the Figure, while in other embodiments it is separate from the keyboard.

The tablet 110 is used for the entry of Chinese characters or other characters not generally available on a standard QWERTY Keyboard. As a result, Chinese or (other) character recognition software is included in each terminal 102 in some embodiments of the invention. Moreover, in some embodiments, the tablet is distinct from those tablets found in conventional PDAs (such as Palm handheld devices for Graffiti entry), where the user's handwritten marks are invisible to the user. Instead, in one embodiment of the invention, the handwritten characters will be visible on the tablet as the user creates them (reminiscent of a magic slate), so that the user can see the entire character before it is entered. As well, in some embodiments the tablet will include predefined touch (or tap) functions, such as “new,” “done,” “space,” and “erase.” When a new character is desired to be entered, the touch function for “new” will be performed. When formation of the character is complete, the touch function for “done” will be performed, and the recognized Chinese character will be entered on the display screen 104 at the cursor insertion point. Because of its ability to receive characters well beyond the Latin character set, terminal 102 uses the Unicode Standard (as opposed to ASCII) in some embodiments of the invention.

In addition, in some embodiments each terminal 102 will include a smartcard reader 114 for receiving smartcards 112, devices shaped like a credit card in some embodiments that store information that is read by the smartcard reader. In other embodiments, the “smartcard” can take on other shapes. In one embodiment smartcard reader 114 is built into the keyboard 106 as shown in FIG. 1, while in other embodiments it is separate from the keyboard.

Each terminal includes a minimal amount of pre-installed software. For instance, each terminal includes scaled-down operating system (OS) software, which can be any operating system software, but in some embodiments it is based on LINUX or OS-9. LINUX is particularly desirable since it is based on an open standard that the Chinese believe works (or can be easily made to work) and believe is more reliable than many other available operating systems. Nonetheless, despite the presence of the operating system software, in many embodiments the end-user of the terminal is never exposed to that operating system software and need never interact with it, greatly easing operation of the terminal.

Despite the OS software included in each terminal, no local storage (such as a hard drive) is included in each terminal 102 in some embodiments. The scaled-down OS is stored in a local memory device, such as flashram. Any other applications are retrieved from the hub on power-on, or when needed in various embodiments, as will be described later.

Examples of the software retrieved from hub 120 includes a complete version of the OS (as opposed to the scaled-down version), a web browser (based on HTML 4.0 in one embodiment), an e-mail program (based on IMAP4 in one embodiment), and a chat, or instant messaging, program (based on ICQ in one embodiment). These programs will be interacted with by the end-user. In addition, the terminal 102 will be able to obtain software to display PDF documents and run JAVA applets.

Each terminal 102 communicates with a hub 120 using a wireless technology such as the IEEE 802.11 Wireless LAN Standard known in the art. The hub 120 is connected to an off-site application service provider (ASP) 150, which provides a web server and ultimately access to the Internet 160. In some embodiments, the hub could be connected to an on-site web server and/or directly to the Internet. In addition, hub 120 is equipped with a smartcard reader 122 and it can be connected to various peripherals, such as printer 132 or scanner 134.

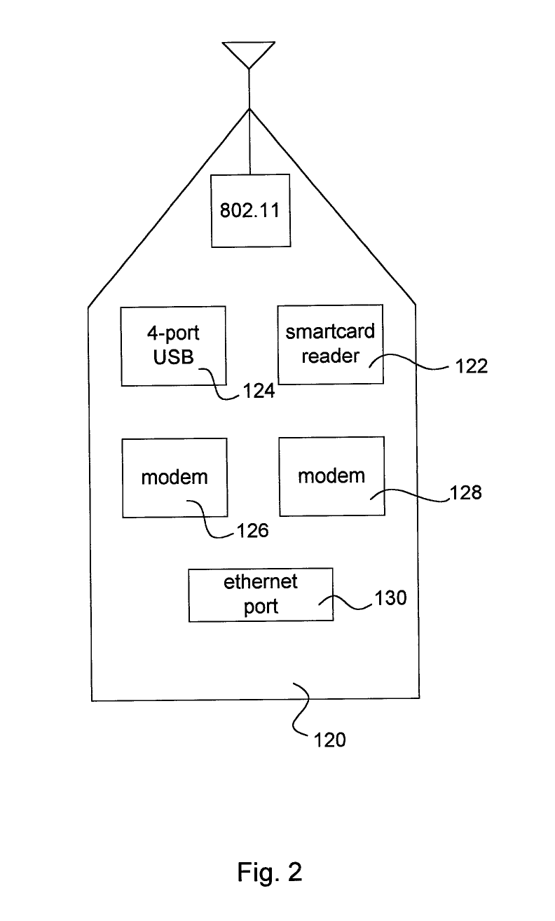

Referring to FIG. 2, in addition to the smartcard reader 122, hub 120 includes three additional card slots 124, 126, 128. One of the card slots is a 4-port USB controller 124, used to connect various peripherals (e.g., printer 132, scanner 134) to the hub 120. In some embodiments, device drivers for USB devices will be loadable modules into the hub 120, and they will download from the server (located at the ASP 150) when the USB device is recognized by the hub. Any terminal 102 will have access to the peripherals via the hub, e.g., to print.

The other two card slots 126, 128 can be used for various devices to form the connection to ASP 150 and/or the Internet. For instance, these slots can be used for an ISDN modem, dual V.90 modems, an xDSL modem, or T1/E1 access cards.

In some embodiments, the hub 120 also includes an ethernet port 130 for connection to a non-wireless LAN, such as a 10/100baseT NE2000 compatible ethernet port. Thus, the hub 120 provides connectivity between a LAN of terminals 102 and an external network served by an ASP 150.

Finally, each hub includes a processor and memory (not shown). In addition to the software required for the above-described functions, the hub 120 will include operating system software for its own operation, such as LINUX in some embodiments. Hub 120 does not require its own dedicated display as its functionality can be accessed and managed when necessary from a terminal 102.

Although both the hub 120 and terminals 102 include various software, such as a scaled-down OS in a terminal 102 and an OS and other software in a hub 120, the devices have all the software pre-installed and pre-configured. The user need do nothing and, in some embodiments, is not even given the ability to access the software to configure it or to add new software, making use easy and painless.

Referring again to FIG. 1, in some embodiments of the invention multiple hubs 120 will be used, to increase the size of the wireless LAN, all communicating by wireless transmission. Only one of these hubs needs to have access to the Internet, although more can have access in some embodiments. If more than one hub has Internet access, then the wireless network is divided into two separate, isolated zones where each hub with Internet access is the master of the zone. However, in those embodiments where only one hub has external access, the connected hub is the master, while the other hubs are slaves. The “master hub” is sometimes referred to herein as the Service Area Director (SAD). In some embodiments the SAD is responsible for authentication within the LAN, NAT, DHCP lease authorization and control, providing network information to the terminals (such as gateway, mask, proxy, and DNS addresses), and maintaining a log of the WLAN status and problems. The log data, in some embodiments, is accessible by the ASP and can be used to indicate when customer service is necessary. In some embodiments, all customer service functions and support occur at the ASP 150.

Although a network in accordance with the invention is generally described as wireless, some embodiments may use both wired and wireless links, or may even use all wired links.

Network security within the wireless network is important and the hub creates a closed network with the terminals. To maintain network security on the wireless network, authentication between the hub and the terminal will be done using wireless equivalent privacy (WEP), or something similar, as is known in the art. Further, hub 120 connects to the ASP 150 via a VPN using an open IPSec Standard in one embodiment. The serial number of the hub 120 is used as a password to the web server. Since the serial number is not accessible to the user, overall system security is improved, and it minimizes the possibility that a user or other third party will reprogram the hub to point to their own servers.

Operation

To set up a system in accordance with the invention, the user of each terminal 102 merely powers it on (after either plugging it into an electrical outlet or providing battery power). Each hub 120 is similarly set up. On power on, each terminal 102 “netboots” from the hub—it obtains the information it needs to run initially from a wireless transmission from the hub 120. More specifically, the scaled-down OS software in the terminal 102 is scaled down to the point where it is just sufficient to perform the netboot process, in one embodiment. Once the power to the terminal 102 is turned on, the terminal (using the scaled-down OS) searches for the nearest hub 102, identifies itself to the hub 102, establishes a secure wireless communication link with the hub 102, and downloads the complete OS and any required (or desired) applications into its memory. In one embodiment, a terminal 102 contains at least 32 MB RAM and 1 MB flashram, although other embodiments may contain more. Once all of the required software is downloaded to the terminal 102, control is passed from the scaled-down OS to the complete downloaded OS.

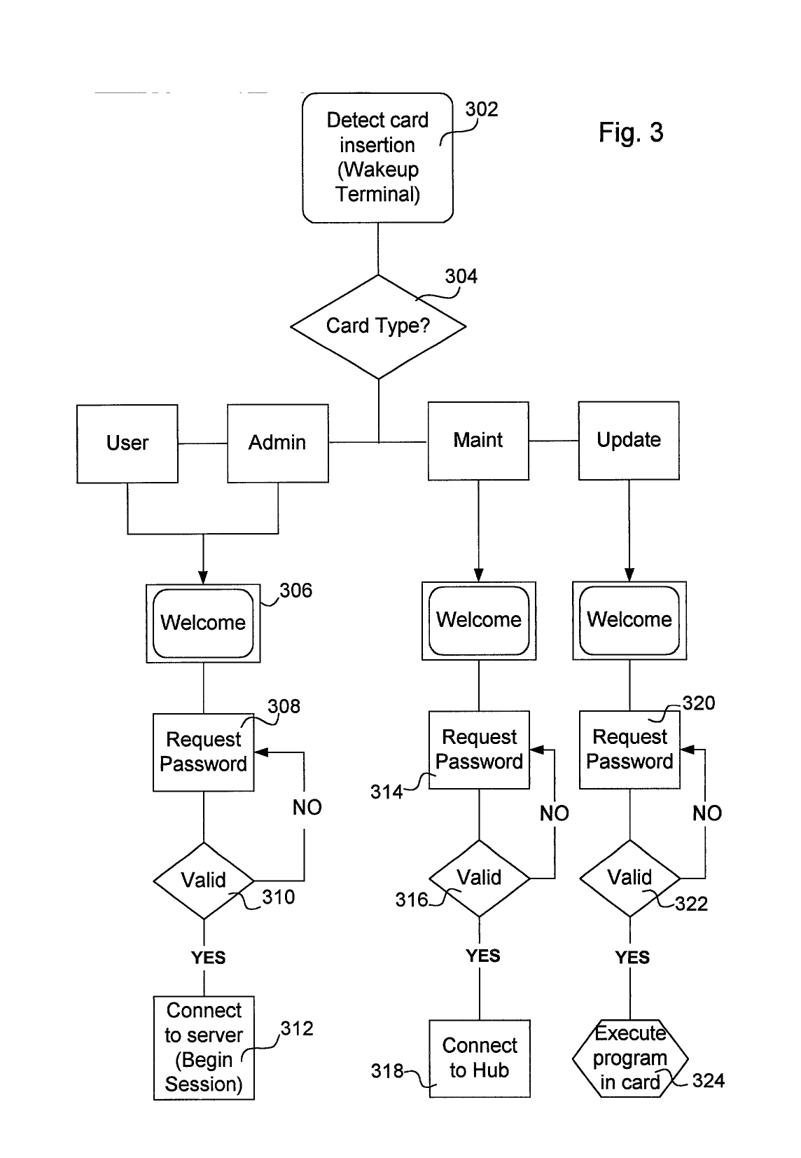

Referring to FIG. 3, once powered on and the netboot is complete, in order to use each terminal 102 and to activate a session, the user inserts the smartcard 112 that was previously assigned to the user, step 302. The system then identifies the card type at step 304 determining whether the card is a user card, an administrative card, a maintenance card, or an update card. The distinctions in these cards will be discussed in detail later.

If the system determines that a user card has been inserted in the terminal, step 304, the user immediately interfaces with the web browser, step 306, and the user never has to interact with the operating system. As a result, there is essentially a zero start-up time once the smartcard 112 is inserted into the terminal's smartcard reader. The user is prompted to enter his or her password at step 308, and the validity of the password is determined at step 310. If invalid, the user is reprompted to enter the password. However, if the password is valid the browser (terminal) is connected to the webserver at ASP 150 through the hub 120, step 312.

Connectivity with the ASP 150 can be routed via the Internet 160 or another wide area network, so security can optionally be enhanced with a VPN (Virtual Private Network) from the hub 120. Whether handled in hardware or software, a key-exchange will occur by User Datagram Protocol (UDP) at the time of smartcard 112 insertion, as will be understood in the art. To maintain compatibility with Encapsulating Security Payload (ESP), Generic Routing Encapsulation (GRE), Internet Security Association and Key Management Protocol (ISAKMP), Authentication Header (AH), and other protocols known in the art, a keep alive signal from the terminal 102 to the hub 120 will generate another keep alive signal from the hub 120 to the ASP 150. If the AH protocol is in use, in some embodiments in tunnel mode a single failed keep alive will cause the terminal to log the user off. Separate authentication between the hub 120 and the ASP 150 may be in transport mode, using a one-way hash algorithm for encryption as will be understood in the art. Security associations will exist in some embodiments on a per-datagram basis to remove the potential for man-in-the-middle attacks known in the art.

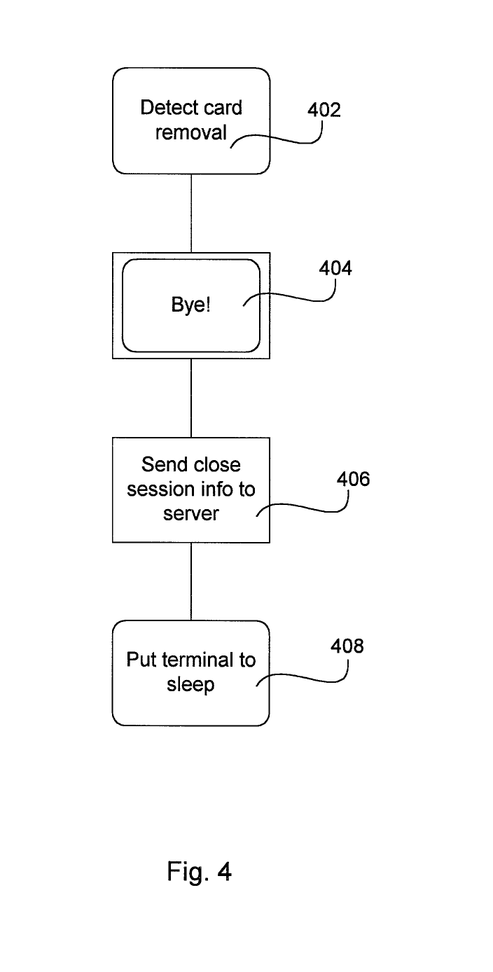

As shown in FIG. 4, to log off the user simply removes his or her smartcard 112, step 402. Alternatively, if the terminal is idle for predertermined period of time, the system will automatically log off. Thus, a keep alive signal or message is periodically sent when the terminal 102 is actively being used. Such a keep alive signal could be a UDP packet (ping) to the web server.

When the system detects a log off either by card removal or by idle time, the terminal displays a log off screen, step 404. The terminal sends (through hub 120) close session information to the web server at ASP 150, step 406. Such close session information includes the user ID, the last URL visited by the user, a timestamp, and other session information. The terminal is then put into a low power or “sleep mode,” step 408, going into a low power mode or turning off completely. Nonetheless, if the terminal 102 is turned off completely the netboot process will need to be reperformed on the next power on, while if in a sleep mode, the downloaded software will not have to be reloaded when the terminal awakes.

Because close session information and other account information regarding each user is sent to and stored at the ASP 150 in one embodiment, the user can log onto any terminal 102 in the WLAN at any later time and continue accessing the Internet where he or she left off in his or her last session. Thus, the user card logs the user on and off the system and creates the means to store and access user data and preferences.

In some embodiments a “guest card” can be used in place of a user card. The guest card is essentially a user card except that there is no password or specific user associated with the guest card. As a result, the guest card cannot access user-specific services, such as a server based e-mail account, and can only browse the web. Thus the steps for use of a guest card are identical to those of a user card in FIG. 3, except steps 308 and 310 are skipped. As well, use of the guest card will not allow a guest user to continue a past session, since no user information is stored.

The second type of card shown in FIG. 3 is the administrative card, referred to herein as the “admin” card. The admin card allows a local administrator to create new accounts (including programming new user cards), delete old accounts, and manage the email system, all from the WLAN site. As shown in FIG. 3, the steps for use of an admin card are similar to the use of the user card. Hence, the admin card holder will insert the admin card to start a session and provide a password. When the web server recognizes the session as an admin session, it will provide access to perform such administrative functions.

A third type of card is the maintenance card, referred to herein as a “maint” card. The maint card allows hub configuration. However, in one embodiment two identical maint cards are required to be used to configure a hub 120, where one card is inserted into the smartcard reader 122 at the hub 120, and the other card is inserted into the smartcard reader 114 at a terminal 102. Inserting a maint card into a hub 120 places the hub in maintenance mode. Once in maintenance mode, the hub 120 searches for a matching maintenance terminal. When a maint card is inserted at a terminal 102 and the terminal recognizes the card as a maint card, the terminal will prompt for a password, step 314, and validate it, step 316. Once validated, access to the hub for maintenance is permitted, step 318. The maintenance hub and maintenance terminal then handshake and set up an isolated, encrypted communication link between themselves. The terminal displays hub configuration screens to the user performing the maintenance.

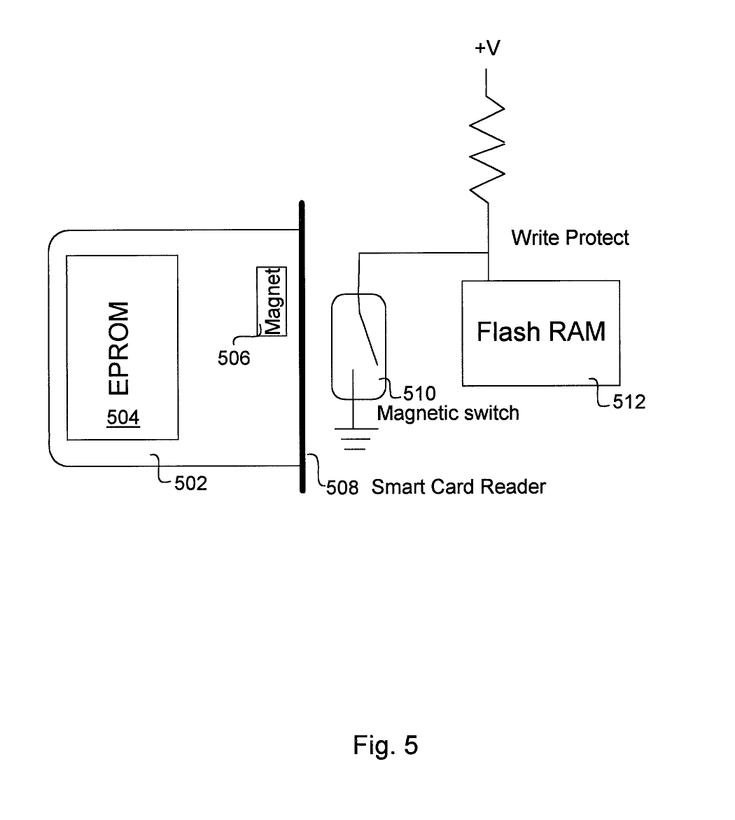

Each hub has its OS and the various applications stored on internal memory, such as a flashram device, and each terminal has its scaled-down OS stored on internal memory, such as flashram. Occasionally, these software applications may need to be updated. For security reasons, the internal memory cannot be updated remotely in some embodiments. Accordingly, the fourth type of smartcard in a system in accordance with an embodiment of the invention is the update card. As shown in FIG. 5, the update card 502 includes an EPROM 504 and a magnet 506. Any software updates are included in the EPROM. The magnet is positioned on the card so that when the card is inserted into smartcard reader 508, it causes a magnetic switch 510 to close. When the switch is closed, it disables the hub's (or terminal's) write protect mechanisms to its internal memory 512. Once recognized as an update card, the password is validated, steps 320 and 322. Once validated, the programming on the update card is executed, step 324. Since the hub does not have a dedicated terminal in many embodiments, two cards (not necessary identical) may be used in some embodiments to establish a secure link between a terminal and the hub before an update is performed, e.g., to receive the password. Because the majority of software is stored on the hub, only one copy of the software will usually need updating.

Thus a system in accordance with the invention has been described that is easy to install and use, has built-in, inherently secure communications, has little to no maintenance and minimal support requirements, and is inexpensive to manufacture (and therefore purchase).

The system has no local storage such as hard drives, allowing the devices to be easily maintained and remain simple, streamlined devices. Further, the devices are designed with business communication tasks in mind. Such communications are mainly informational, minimizing the hardware and software “bells and whistles” (like speakers, cameras, and specialized graphics and sound cards) that add to and complicate many consumer products that are designed with multimedia in mind.

Although a system and method in accordance with the invention was designed with the Chinese business market in mind, it should not be construed as being limited to that market. A system and method in accordance with the invention will in fact be useful worldwide.

It should be understood that the particular embodiments described above are only illustrative of the principles of the present invention, and various modifications could be made by those skilled in the art without departing from the scope and spirit of the invention. Thus, the scope of the present invention is limited only by the claims that follow.

What is claimed is:

1. A networking system, comprising:
an on-site hub in communication with an off-site network; and
a plurality of on-site terminals in wireless communication with the hub, forming a wireless local area network, each terminal allowing access to web browser functionality and having access to the off-site network through the hub.

2. The networking system of claim 1, wherein the hub is further in communication with a peripheral, wherein each terminal has access to the peripheral through the hub.

3. The networking system of claim 1, further including:
a second on-site hub in communication with the hub.

4. The networking system of claim 1, wherein each terminal includes:
a smartcard reader for receiving a smartcard assigned to a designated user for insertion in the smartcard reader, wherein the smartcard stores information associated with the designated user.

5. The networking system of claim 1, wherein the hub is in communication with an off-site network via an off-site web server.

6. The networking system of claim 1, wherein the hub is in communication with an off-site network via an off-site web server, wherein the web server maintains account information about the users of the wireless local area network so that a user can use any terminal.

7. The networking system of claim 1, wherein each terminal further includes e-mail and chat applications.

8. A networking system, comprising:
a hub in communication with the Internet;
a terminal in wireless communication with the hub, the terminal allowing access to web browser functionality and including a smartcard reader; and
a smartcard assigned to a designated user for insertion in the smartcard reader, wherein insertion of the smartcard initiates a user session.

9. The system of claim 8, wherein upon removal of the smartcard, the user session ends.

10. The system of claim 9, wherein when the user session ends, information regarding the user session is stored.

11. The system of claim 8, wherein information regarding the user session is stored, and wherein upon insertion of the smartcard to initiate a subsequent user session, the stored user session information is restored to the terminal thereby allowing the user to continue the user session in the subsequent user session.

12. The system of claim 8, wherein the terminal requires no user setup to operate.

13. The system of claim 8, wherein the smartcard is one of a user card, an administrative card, a maintenance card, or an update card.

14. The system of claim 8, wherein the hub is in communication with the Internet via an off-site web server.

15. A networking system, comprising:
an on-site hub in communication with an off-site application service provider (ASP) having a web server;
a plurality of on-site terminals in wireless communication with the hub, forming a wireless local area network, each terminal allowing access to web browser functionality and having access to the ASP through the hub and including a smartcard reader;
a smartcard assigned to a designated user for insertion in the smartcard reader, wherein insertion of the smartcard initiates a user session and wherein the smartcard stores information associated with the designated user.

16. The networking system of claim 15, wherein the hub is further in communication with a peripheral, wherein each terminal has access to the peripheral through the hub.

17. The networking system of claim 1, further including:
a second on-site hub in communication with the hub.

18. The system of claim 15, wherein upon removal of the smartcard, the user session ends.

19. The system of claim 15, wherein information regarding the user session is stored at the ASP, and wherein upon insertion of the smartcard to initiate a subsequent user session, the stored user session information is restored to the terminal thereby allowing the user to continue the user session in the subsequent user session.

20. The system of claim 15, wherein the smartcard is one of a user card, a guest card, an administrative card, a maintenance card, or an update card.

21. A wireless local area network (WLAN), comprising:
a terminal, including:
a display;
a keyboard;
a pointing device;
a writing tablet for input of non-latin characters;
a wireless transceiver;
a smartcard reader; and
a hub able to receive wireless communications from the terminal, including:
an Internet connection mechanism;
a peripheral connection mechanism;
a wireless transceiver;
a smartcard reader;
at least one memory device storing an operating system and a web browser application;
wherein the terminal further includes at least one memory device storing a scaled-down operating system, wherein the scaled-down operating system is scaled-down in comparison with the operating system stored on the hub, wherein the scaled-down operating system is capable of initiating a wireless connection between the hub and the terminal and downloading the operating system and the web browser application.

22. A method of establishing a web browsing session, comprising:
receiving a smartcard by a terminal;
using information stored on the smartcard to recall past session information;
displaying the past session information, thereby allowing the user to continue a past session.

23. The method of claim 22, further comprising:
detecting the removal the smartcard from the terminal;
sending close session information to a web server.
